(19) United States
(12) Patent Application Publication
(10) Pub. No.: US 2012/0189876 A1
(43) Pub. Date: Jul. 26, 2012

(54) FUEL CELL PURGE SYSTEM

(75) Inventors: TIBOR FABIAN, MOUNTAIN VIEW, CA (US); TOBIN FISHER, SAN FRANCISCO, CA (US); DANIEL BRAITHWAITE, SAN FRANCISCO, CA (US)

(73) Assignee: Ardica Technologies, Inc., San Francisco, CA (US)

(21) Appl. No.: 13/286,025

(22) Filed: Oct. 31, 2011

Related U.S. Application Data
(63) Continuation-in-part of application No. 12/322,337, filed on Jan. 29, 2009.
(60) Provisional application No. 61/408,388, filed on Oct. 29, 2010.

(51) Int. Cl. H01M 8/04; H01M 8/24; H01M 16/00

(52) U.S. Cl. 429/9; 429/446; 429/432; 429/442

(57) ABSTRACT

A fuel cell purge system including a fuel cell assembly, a fuel supply that supplies fuel to the fuel cell assembly at a first flow rate, an adjustable load that applies a load on the fuel cell assembly, and a purge valve coupled to the fuel cell assembly, and a purge management module. The fuel cell purge system purges the fuel cell assembly by detecting a purge initiation event, adjusting a system parameter to initiate a purge, detecting a purge completion event, and adjusting a system parameter to cease the purge.

### CROSS-REFERENCE TO RELATED APPLICATIONS

This application is a continuation-in-part of prior application Ser. No. 12/322,337 filed 29 Jan. 2009, which is incorporated in its entirety by this reference. This application also claims the benefit of U.S. Provisional Application No. 61/408,388 filed 29 Oct. 2010, which is incorporated in its entirety by this reference.

### TECHNICAL FIELD

This invention relates generally to the fuel cell field, and more specifically to a purge system for fuel cells.

### BACKGROUND

Fuel cell systems in which oxygen is supplied from ambient air tend to accumulate the non-reactive components of air and fuel-generation products. Primarily, nitrogen and water condensation are accumulated in the fuel stream due to finite diffusion rates of gases through the fuel cell electrolyte. This inert fluid accumulation eventually results in a drop in fuel concentration, causing the fuel cell voltage and power output to fall. Consequently, continuous operation of these fuel cells requires periodic purging of the fuel compartment. Therefore, there exists a need in the fuel cell field for a purge system for fuel cells.

### BRIEF DESCRIPTION OF THE FIGURES

FIG. 1 is a schematic representation of a fuel cell purge system.

FIG. 2 is a schematic representation of a fuel cell purge system having detection for a completed purge based on a timer.

FIG. 3 is a schematic representation of a fuel cell purge system with fuel cell arrangement with in-series fuel routing, wherein the purge exhaust is routed over the cathode of a fuel cell in the arrangement.

FIGS. 4 and 5 are schematic representations of a fuel cell purge system wherein the purge exhaust is routed into the anode of an auxiliary fuel cell and routed over a catalyst bed, respectively.

FIG. 6 is a flow chart of the method of purging a fuel cell system.

FIG. 7 is a schematic representation of an embodiment of the method of purging a fuel cell system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Fuel Cell Purge System

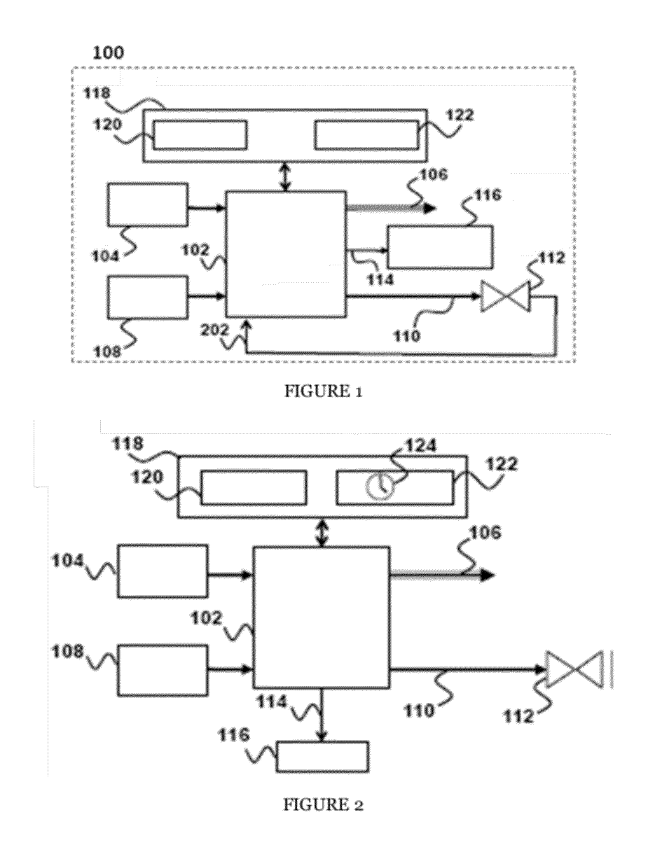

As shown in FIG. 1, the fuel cell purge system 100 of the preferred embodiment includes a fuel cell arrangement 102, a fuel supply 108, a purge valve 112, an adjustable load 116, and a purge management module 118. The fuel cell purge system 100 is preferably used to purge non-fuel matter no generated by a fuel cell, such as condensed water and non-fuel gasses (e.g., nitrogen). The fuel cell purge system 100 is preferably used to purge fuel cell systems used in portable consumer devices, such as laptops, cell phones, and media players, but may alternatively be used to purge fuel cell systems used in personal heating systems (e.g., the system described in U.S. application Ser. No. 11/124,401 and U.S. Pat. No. 7,637,263), in fuel-cell driven vehicles, or in any other applications that may use fuel cells as a power source. The advantages of incorporating the fuel cell purge system 100 may include increased fuel cell efficiency and/or increased power output.

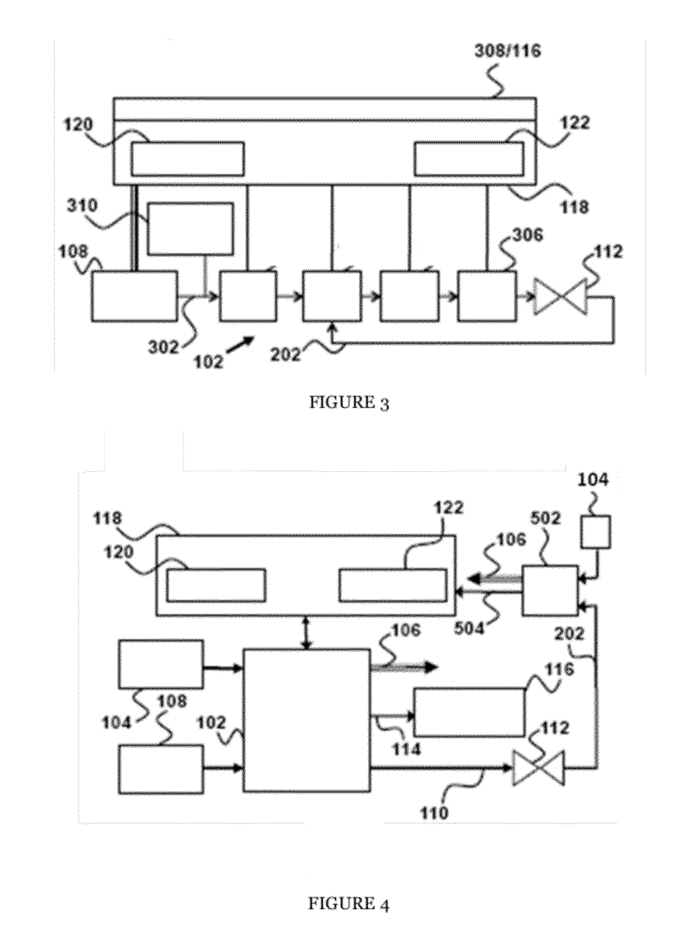

The fuel cell arrangement 102 of the fuel cell purge system 100 functions to convert fuel into electricity. Preferably, the fuel cell arrangement 102 includes a proton exchange membrane (PEM) fuel cell, wherein gaseous fuel is passed over the anode of the PEM and an oxygen-containing gas stream 104 is passed over the cathode. The PEM separates the fuel into protons and electrons, allowing the protons to pass through the membrane to combine with the oxygen at the cathode to form water while conducting the electrons to a load electrically coupled to the fuel cell. Alternatively, the fuel cell arrangement 102 may include any fuel cell that may require purging. Fuel is preferably pumped into the fuel cell arrangement 102, but may alternatively diffuse or otherwise flow into the fuel cell arrangement 102. Likewise, the oxygen-containing gas stream 104 is preferably pumped into the fuel cell arrangement 102, but may alternatively diffuse or otherwise passively flow into the fuel cell arrangement 102. The fuel cell arrangement 102 may be a single fuel cell, several fuel cells with parallel fuel routing, several fuel cells with in-series fuel routing (as shown in FIG. 3), an array of fuel cells, or any combination of the aforementioned arrangements. The fuel cell is preferably a hydrogen fuel cell, but may alternately be a propane fuel cell, a butane fuel cell, a methane fuel cell, or any combination thereof.

The fuel supply 108 of the fuel cell purge system 100 functions to provide fuel to the fuel cell, and is preferably fluidly coupled to the fuel cell arrangement 102, either in series or in parallel. Because the mass of fuel in the fuel cell arrangement 102 determines the system pressure, the fuel flow rate from the fuel supply 108 to the fuel cell arrangement 102 may also function to control the system purge. The fuel flow rate may be the rate at which fuel is transferred from a fuel container (e.g. a hydrogen cartridge) to the fuel cell assembly, or may be the rate at which fuel is generated by a fuel generator. While the fuel supply 108 preferably provides fuel to the fuel cell arrangement 102 at a constant flow rate, the flow rate of the fuel supply 108 is preferably adjustable (e.g. by providing more power to the fuel supply pump, by sending a command to the pump, by changing the throttling on the fuel supply outlet, etc). The fuel supply 108 preferably provides hydrogen gas, but may alternatively provide propane, butane, methane, or any other suitable fuel for use with a fuel cell. The fuel supply 108 can be a container with pure fuel (e.g. a canister of H₂ gas), but is preferably a fuel generator, such as the one described in U.S. application Ser. Nos. 12/501,675 or 12/803,965 (which are both incorporated in their entirety by this reference), and utilize a control mechanism (e.g. pump) such as the one described in U.S. application Ser. No. 11/203,001 (which is incorporated in its entirety by this reference). However, the fuel supply 108 may be any other suitable system that supplies fuel.

The purge valve 112 of the fuel cell purge system 100 functions to vent the fuel cell arrangement 102. The purge valve 112 is fluidly coupled to the interior of the fuel cell arrangement 102, and may be electrically or mechanically coupled to the controller. The purge valve 112 is preferably coupled to the anode flow path (fuel flow path) of a fuel cell, and is preferably located within the anode flow path, but may alternately be located in the anode manifold that connects the fuel cells of the fuel cell arrangement 102. Alternatively, the purge valve may be coupled to any suitable portion of the fuel cell arrangement 102. In an fuel stack with in-series fuel routing, the purge valve 112 is preferably coupled to the last cell 306 of the fuel cell arrangement 102, wherein the last cell 306 is the fuel cell furthest from the fuel supply 108, as determined by the fuel flow path. However, the purge valve may be coupled to any suitable fuel cell within the fuel cell arrangement 102. In a parallel fuel stack, the purge valve 112 may be coupled the end of any fuel cell in the stack, wherein the end of a fuel cell is the end furthest from the fuel supply 108. The purge valve 112 is preferably a passive valve, but may alternatively be an active valve. Passive valves that may be used include unidirectional valves, such as ball valves and check valves, or bidirectional valves, such as dome valves. Active valves that may be used include solenoid valves, hydraulic valves, pneumatic valves or motor valves, and may be unidirectional, bidirectional, or 3-way valves. The purge valve 122 preferably has a cracking pressure above 1 psi, but may alternatively have any suitable cracking pressure. When an active valve is used, it is preferably electrically coupled (e.g. via a wired or wireless connection) or mechanically coupled (e.g. via an actuator or a linkage) to the controller. Although preferably only one purge valve 112 is used in the fuel cell purge system 100, the fuel cell purge system 100 may include two purge valves 112 (e.g. an active valve with a passive valve as an emergency release valve), or multiple valves, depending on the arrangement of the fuel cells (e.g. an fuel stack with in-series fuel routing may only need one purge valve 112 proximal to the last cell 306, but a parallel fuel stack may need multiple purge valves 112 proximal to the end of each fuel cell in the stack). Alternately, the purge valve 112 may have multiple passageways (e.g. a 3-way valve) such that the purge valve 112 and the fuel supply 108 couple are the same valve, and the fuel cell arrangement 102 is purged at a point proximal to fuel introduction into the fuel cell arrangement 102.

The adjustable load 116 of the fuel cell purge system 100 functions to control the amount of current demanded from the fuel cell. Because the current demand on the fuel cell directly determines the amount of fuel consumed by the fuel cell (i.e. the more current demanded, the more fuel consumed), the adjustable load 116 may additionally function to control and manipulate system pressure. While not purging, the adjustable fuel cell load may be adjusted to maintain operating pressure, effectively matching the fuel consumption by the fuel cell to the fuel flow-rate of the fuel supply 108. The adjustable load 116 is preferably a DC/DC converter optionally coupled to an energy storage device (e.g. a battery or a capacitor) included in the fuel cell purge system 100, but may alternatively be a DC/AC converter included in the fuel cell purge system 100, or a DC/DC converter optionally coupled with an energy storage device (e.g. a battery or a capacitor) included in the consumer product device. The adjustable load 116 may additionally include a battery charger circuit coupled to a battery 308, wherein the charging current of the battery 308 can be adjusted based on the electricity production of the fuel cell arrangement 102. This battery 308 may serve as a hybridizing device that can support continuous (no power outputs or interrupts during system startup and purges) as well as peak power output from the fuel cell system to an external user load.

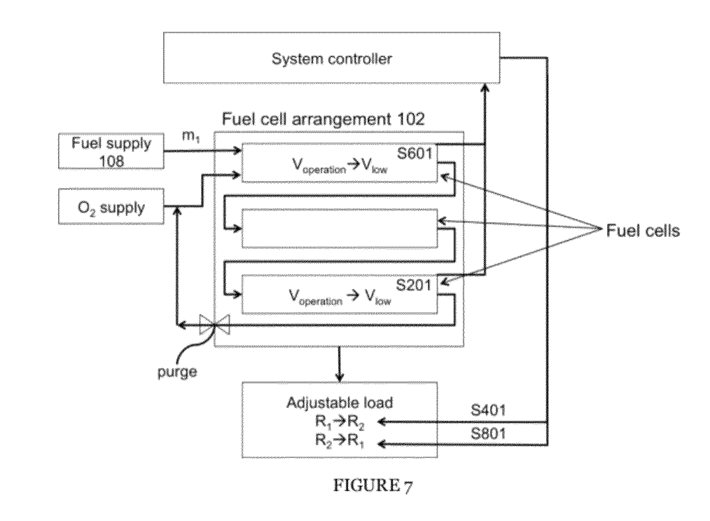

The purge management module 118 of the fuel cell purge system 100 functions to measure system parameters and determine whether a purge should be initiated or completed. The purge management module 118 may additionally function to control system purging by controlling system parameters, and preferably operates between a purging mode, wherein the system is being purged, and an operating mode, wherein the system is operating at steady state (i.e. not being purged). The purge management module 118 preferably includes a purge request module 120 that detects an initiation event and a purge complete module 122 that detects a completion event, which are used to determine whether a purge should be initiated or completed, respectively. The purge management module 118 preferably also includes a controller that functions to process the outputs of the purge request and complete modules 120 and 122, and to control/adjust system parameters to initiate, control, and cease the purge. The controller is preferably a processor such as a CPU, but may alternatively be an electronic switch (e.g. a NAND gate or an AND gate). The controller is preferably located within the fuel cell assembly 102, but may alternatively be located in any component of the fuel cell system 100. The purge management module 118 functions to control purging by controlling the opening and closing of the purge valve 112, and is preferably electrically or mechanically coupled to the purge valve 112. The purge management module 118 may additionally function to control purging by controlling the load of the adjustable load 116 and the fuel flow rate of the fuel supply 108, in which case the purge management module 118 is also coupled (e.g. electrically or wirelessly) to the aforementioned elements of the fuel cell purge system 100. As shown in FIG. 6, the purge management module 118 preferably initiates the purge by opening the purge valve 112 when an initiation event is detected by the purge request module 120, and completes the purge by closing the purge valve 112 upon detection of a completion event by the purge complete module 122. Since the system preferably utilizes a passive purge valve 112, the purge management module 118 preferably opens the purge valve 112 by increasing the internal pressure past the purge valve's 112 cracking pressure. This is preferably accomplished by holding the fuel flow rate of the fuel supply 108 constant while decreasing the load on the fuel cell, effectively keeping the fuel input constant while decreasing consumption, resulting in an increase in internal pressure. Alternately, the purge management module 118 can increase the internal pressure by holding the load on the fuel cell arrangement 102 constant while increasing the fuel flow rate, effectively increasing the fuel input while keeping the consumption constant to result in an increase in internal pressure. The purge management module 118 may also achieve this increase in system pressure by using any other combination of increasing, decreasing, or maintaining the fuel flow rate of the fuel supply 108 and the load of the adjustable load 116, or by adjusting any other system parameter (e.g. temperature, purge valve cracking pressure). When a completion event is detected by the purge complete module 122, the purge management module 118 adjusts the fuel flow rate, the load, or any other system parameter to bring the system back to operating pressure. Alternately/additionally, an active purge valve 112 may be used, wherein the purge management module 118 sends a signal to open the active valve upon receipt of a signal from the purge request module 120, and sends a signal to close the active valve upon receipt of a signal from the purge complete module. During a purge with an active valve, the purge management module 118 may lower both the fuel flow rate and the load in order to prevent fuel leakage, or may alternatively keep both the fuel flow rate and the load at operating levels, increase only the fuel flow rate, decrease only the load, or implement any combination of increasing, decreasing, or maintaining the fuel flow rate and load during the purge. By using an active valve in the system, the purge management module 118 may also alter the system parameters such that a high internal pressure is built up within the system to maximize the purge force and reduce the purge time. This increased pressure can be achieved either by purging less frequently (e.g. having more extreme critical parameter thresholds than when using a passive valve), or by raising the internal pressure right before the purging event.

The purge request module 120 functions to detect a purge initiation event. The purge request module 120 preferably detects the voltage drop of a given fuel cell below a threshold voltage as the initiation event, and includes a voltage sensor coupled to the fuel cell most proximal to the purge valve 112, but may include a voltage sensor coupled to any of the fuel cells in the fuel cell arrangement 102, or multiple voltage sensors coupled to multiple fuel cells in the fuel cell arrangement 102. The purge request module 120 may also detect the power output, the current load, or the resistance of any given fuel cell, wherein the detection of a drop in the power output, a drop in the current load, an increase in the resistance of a fuel cell serves as the initiation event, or a combination thereof. The purge request module 120 may also detect more complicated criteria, such as the deviation of one fuel cell compared to the average of all cells, effectively utilizing all cell information. For example, the purge request module 120 may use a model to predict how long it takes to build up nitrogen in the stack based on operating parameters (current, stack temperature, hydration, etc). Upon determination of a positive output of the purge request module 120, the controller of the purge management module preferably initiates a purge (e.g. by opening an active valve or increasing system pressure).

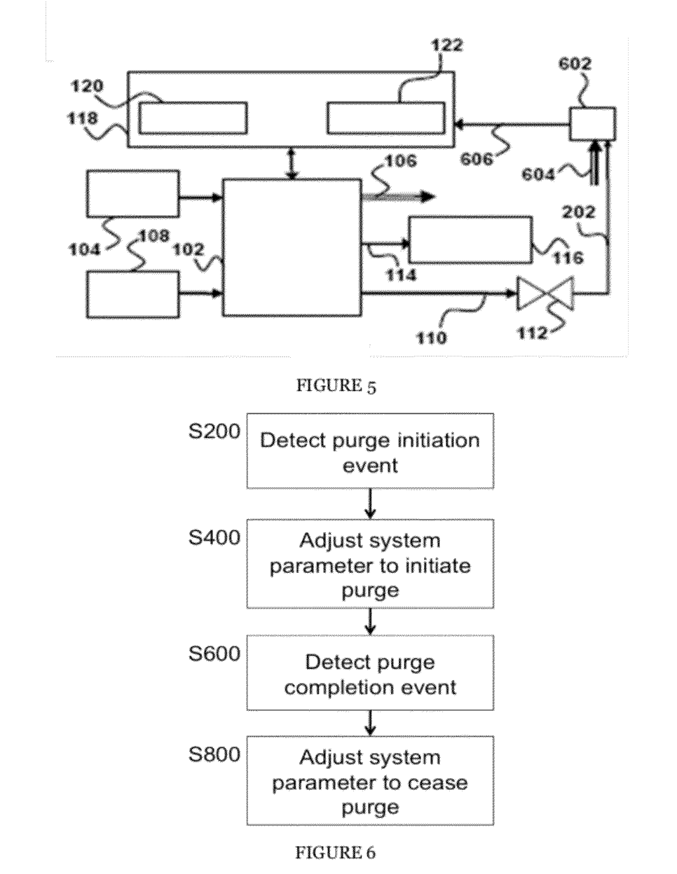

The purge complete module 122 functions to detect a purge completion event. As shown in FIG. 2, the purge complete module 122 preferably measures the time since initiation of a purge as the completion event, wherein the duration of time is determined according to a current load in any of the hydrogen fuel cells before the purge was initiated. The current load before purge is indicative of the hydrogen flow rate before the purge, so the duration of the purge can be determined from the hydrogen flow rate and the known volume of the fuel cell anode. The purge complete module 122 in this embodiment is preferably a timer 124 coupled to a current sensor, which in turn is coupled to a fuel cell in the fuel cell arrangement 102. Alternately, the purge complete module 122 may detect the composition of the purged gas, wherein the completion event occurs when the purge stream 202 is primarily fuel. As shown in FIG. 3, the purge complete module 122 preferably achieves this by measuring a voltage drop in a fuel cell, but may additionally/alternately determine when the purge stream 202 is primarily fuel by measuring a current or voltage increase in a fuel cell or by measuring a temperature increase over a catalyst. The purge complete module 122 preferably measures the voltage drop in a fuel cell by routing the purge stream 202 over the cathode of the first cell (in order of receiving gas flow) of the fuel cell arrangement 102, wherein the completion event is a voltage drop that results from catalytic oxygen starvation on the air side of the fuel cell. However, the purge complete module 122 may alternately route the purge stream 202 over any cathode of any fuel cell in the fuel cell arrangement 102. The completion event is preferably the fuel cell voltage dropping past a predetermined threshold, but may be the voltage dropping past a threshold percentage of the operating voltage, or any other suitable completion event. The purge stream 202 is preferably routed over the center of the cathode, but may alternatively be routed over the edges of the cathode as well. As shown in FIG. 4, the purge complete module 122 may also detect fuel in the purge stream 202 by detecting an increase in the current or voltage of a fuel cell above a threshold level by routing the purge stream 202 over a fuel sensor, such as the anode of an auxiliary fuel cell 502. This method detects fuel in the purge stream 202 because initially, when inert gas and other non-fuel matter 110 is being purged into the anode, the open cell voltage 504 of the auxiliary fuel cell 502 is low, and the auxiliary fuel cell current, when loaded, is minimal. Once all of the inert gas has been purged and pure fuel is being purged instead, the open cell voltage 504 of the auxiliary fuel cell 502 increases and the cell current under load substantially increases. Therefore, comparing the load current of the auxiliary fuel cell 502 to a threshold value can indicate hydrogen purity in the purge stream 202. In this embodiment, the purge complete module 122 further includes an auxiliary fuel cell 502. As shown in FIG. 5, the purge complete module 122 may also detect fuel in the purge stream 202 by measuring the temperature 606 over a catalyst bed 602 in fluid contact with ambient air 604. In this method, the purge complete module 122 routes the purge stream 202 over the catalyst, which causes any fuel in the purge stream 202 to catalytically combust. Initially, when inert gas and other non-fuel matter 110 are purged across the catalyst bed 602, the gasses pass over the catalyst bed 602 without reaction. Once all the non-fuel matter 110 is purged and pure fuel is purged instead, the fuel reacts exothermically with ambient in the presence of the catalyst, causing an increase in temperature 606 at the catalyst site. In this embodiment, the purge complete module 122 further includes a catalyst or a catalyst bed 602 in fluid contact with ambient air 604. The catalyst preferably includes metals from the Platinum group, oxides of silver, cobalt, manganese or any other catalyst with suitable catalytic reactivity at room temperature, and is preferably configured to allow mixing of ambient air with the purge exhaust (e.g. by diffusion or venturi entraining). The purge complete module 122 may alternatively be a timer, wherein the duration of the timer is preferably determined according to a current load of any given fuel cell. The current load before purge is indicative of the fuel flow rate to the fuel cell before the purge; based on the fuel flow rate and the known volume of the fuel cell anode, the purge duration needed to purge the fuel cell may be determined. The output of the purge complete module 122 is preferably sent to the controller of the purge management module, but may alternatively be sent directly to the purge valve 112 (if an active valve is used), wherein the signal of a completion event (e.g. a voltage change) switches the active valve to a closed (i.e. non-purging) state. Upon receipt of a positive output from the purge complete module 122, the purge management module 118 preferably adjusts the system parameters back to the previous operational parameters (e.g. the system pressure is returned to the operational pressure before purging, the load on the system is increased back to the operational load before purging, etc.). Operational parameters are preferably achieved by reversing the system adjustments that induced purging, but may alternately be achieved by altering other system parameters (e.g. the load on the system is increased to accommodate an increased purging flow rate from the fuel supply 108, instead of lowering the flow rate back down to the first flow rate).

### 2. Method for Purging a Fuel Cell System

As shown in FIG. 6, the method for purging a fuel cell system includes the steps of detecting a purge initiation event S200, adjusting a system parameter to initiate a purge S400, detecting a purge completion event S600, and adjusting a system parameter to cease the purge S800. The method is preferably used to purge non-fuel matter generated by a fuel cell, such as condensed water and non-fuel gasses such as nitrogen. The method is preferably used by the system described above (including a fuel cell arrangement, a fuel supply, an adjustable load, and a purge valve) to purge fuel cell systems used with portable consumer devices, such as laptops and cell phones, but may alternatively be used to purge fuel cell systems used in personal heating systems (e.g., the system described in U.S. application Ser. No. 11/124,401 and U.S. Pat. No. 7,637,263), in fuel-cell driven vehicles, or in any other applications that may use fuel cells as a power source. The advantages of incorporating the fuel cell purge system may include increased fuel cell efficiency and/or increased power output.

The step of detecting a purge initiation event S200 functions to determine when a purge should be initiated. This step preferably includes the steps of monitoring fuel cell system parameters and detecting a system parameter meeting or passing a given threshold (the purge initiation event). As shown in FIG. 7, this step preferably includes the steps of monitoring the voltage of a fuel cell within the fuel cell arrangement, and detects a drop in fuel cell voltage (e.g. below a threshold voltage, below a threshold percentage of the operational voltage, etc) as the initiation event S201. When the fuel cell fuel routing is in-series, the last fuel cell is preferably monitored, as the fuel flow through the system preferably pushes and accumulates all the non-fuel gasses in the anode of the last fuel cell. When the fuel cell arrangement is a parallel fuel cell stack, any fuel cell may be monitored. However, any suitable fuel cell in any suitable fuel cell arrangement may be monitored. Furthermore, this step may monitor the power output, the current load, or the resistance of any given fuel cell, wherein the detection of a drop in the power output, a drop in the current load, or an increase in the resistance of a fuel cell serves as the initiation event, or a combination thereof. This step may also monitor more complicated criteria, such as the deviation of one fuel cell compared to the average of all cells, effectively utilizing all cell information. For example, this step may include using a model to predict how long it takes to build up nitrogen in the fuel cell arrangement based on operating parameters (current, stack temperature, hydration, etc). This step is preferably performed by the purge request module of the purge management module, but may be performed by any suitable set of sensors and controllers.

As shown in FIG. 6, the step of adjusting a system parameter to purge the system S400 functions to open the purge valve to purge the system. The adjusted system parameter is preferably pressure, wherein the system pressure is increased to a purging pressure, but may alternatively be the fuel flow rate from the fuel supply, the purge valve state, or any other suitable system parameter. As the system preferably utilizes a passive purge valve, the purging pressure is preferably increased past the valve's cracking pressure. As shown in FIG. 7, this is preferably accomplished by holding the fuel flow rate substantially constant while decreasing the load on the fuel cell arrangement S401. This effectively keeps the fuel input constant while decreasing the fuel consumption, resulting in an internal pressure increase. However, the system may alternatively/additionally include an active valve. The step of purging the system may alternatively/additionally include holding the load constant while increasing the flow rate; opening the purge valve; increasing the flow rate (e.g. by increasing the pumping rate, by increasing the power provided to the fuel supply pump, etc.) and holding the purge valve closed until the desired purging pressure is achieved (allowing for a relatively fast purge); or any suitable combination of controlling the purge valve state in cooperation with increasing, decreasing, or maintaining the fuel flow rate, applied load, or any other suitable operational parameter. This step is preferably performed by the purge management module and the corresponding system components (e.g. if the load is adjusted to initiate a purge, this step is performed by the adjustable load), but may be performed with any suitable system component.

As shown in FIG. 6, the step of detecting a purge completion event S600 functions to determine when the purge should be ceased. Because fuel is preferably used to purge the system (e.g. by increasing the system's internal pressure), this step is desirable in minimizing the amount of fuel wasted in purging. Furthermore, because fuel is being used to push the non-fuel gasses out of the system, purge completion may be indicated by detecting fuel, more preferably an increase in fuel, within the purge stream. This step preferably includes the steps of routing the purge stream over a fuel sensor that detects fuel within the fuel stream, and monitoring a parameter of the fuel sensor. The fuel sensor is preferably a test fuel cell, wherein the purge stream is preferably routed over the fuel cell cathode, and a drop in the fuel cell voltage (e.g. past a voltage threshold, past a percentage of the operational voltage, etc) is preferably detected as the purge completion event (as shown in FIG. 7, S601). A drop in the fuel cell voltage is indicative of the presence of fuel in the purge stream because the fuel displaces the oxygen within the stream, effectively starving the fuel cell of oxygen and lowering the output voltage. Alternately, the purge stream may be routed over the fuel cell anode, wherein an increase in the fuel cell voltage (e.g. past a voltage threshold, past a percentage of the operational voltage, etc) is detected as the purge completion event. The test fuel cell is preferably a fuel cell in the fuel cell arrangement, more preferably the first fuel cell in a fuel cell stack with in-series fuel routing (particularly when the purge stream is routed over the cathode), but may alternatively be an auxiliary fuel cell or any suitable fuel cell within the fuel cell arrangement. Alternatively, the fuel sensor may be a catalyst bed, wherein an increase in the temperature over the bed is detected as the purge completion event. The catalyst bed may include platinum, palladium, ruthenium, manganese oxide, silver oxide, cobalt oxide, or any other suitable catalysts. Alternatively, detecting the completion event may include timing the purge duration, monitoring the amount of fuel used during purging, or any other suitable indicator of purge completion.

As shown in FIG. 6, the step of adjusting a system parameter to cease the purge S800 functions to close the purge valve. This step is preferably performed in response to the positive determination of a purge completion event. The adjusted system parameter is preferably the pressure of the system, but may alternatively be the fuel flow rate, the purge valve state, the temperature, or any suitable system parameter. The purge is preferably ceased by reversing the system adjustment performed to achieve purging, but may alternatively be ceased by adjusting an operational parameter different from the first. For example, if the load was decreased to initiate the purge, the purge is preferably ceased by increasing the load on the system, such that the fuel consumption rate matches the fuel flow rate into the fuel cell assembly (as shown in FIG. 7, S801). However, the purge may alternatively be ceased by decreasing the fuel flow rate into the system, by increasing the volume of the fuel flow channels (e.g. changing the anode manifold volumes), or by any other suitable method of lowering the system pressure. The purge may alternatively be ceased by lowering the fuel flow rate, by closing the purge valve, or through any combination of increasing, decreasing, or maintaining the fuel flow rate and applied load in cooperation with purge valve state control. This step is preferably performed by the purge management module and any associated system component (e.g. the adjustable load if the load is to be lowered), but may be performed by any suitable system component.

As a person skilled in the art will recognize from the previous detailed description and from the figures and claims, modifications and changes can be made to the preferred embodiments of the invention without departing from the scope of this invention defined in the following claims.

We claim:

1. A fuel cell purge system comprising:
a fuel cell assembly;
a fuel supply that supplies fuel to the fuel cell assembly at a first flow rate;
an adjustable load that applies an electrical load to the fuel cell assembly;
a purge valve coupled to the fuel cell assembly; and
a purge management module that adjusts the fuel cell assembly pressure, wherein the purge management module includes a purge request module that detects a purge initiation event and a purge complete module that detects a purge completion event; wherein the purge management module increases the assembly pressure to a purging pressure upon detection of a purge initiation event, and decreases the assembly pressure to an operational pressure upon detection of a purge completion event.

2. The purge system of claim 1, wherein the purge management module adjusts the load on the fuel cell assembly to adjust the assembly pressure.

3. The purge system of claim 2, wherein the purge valve is a passive purge valve with a cracking pressure; wherein the purging pressure is at least the cracking pressure, and the operating pressure is lower than the cracking pressure.

4. The purge system of claim 3, wherein the cracking pressure of the purge valve is at least 1 psi.

5. The purge system of claim 3, wherein the passive purge valve is a dome valve.

6. The purge system of claim 1, wherein the adjustable load includes an adjustable battery charging circuit coupled to a battery, wherein adjusting the battery charging circuit adjusts battery charging.

7. The purge system of claim 1, wherein the purge detection module detects a voltage drop in the fuel cell arrangement past a predetermined voltage threshold as the purge initiation event.

8. The purge system of claim 7, wherein the fuel cell arrangement is a fuel cell stack with in-series fuel routing, wherein the purge detection module detects a drop in the last fuel cell of the fuel cell stack as the purge initiation event.

9. The purge system of claim 1, wherein the purge complete module includes a fuel detector, wherein the purge complete module detects a fuel increase within the purge stream as the purge completion event.

10. The purge system of claim 9, wherein the fuel detector includes a test fuel cell, wherein the purge complete module directs the purge stream over the test fuel cell, and wherein the purge complete module detects a change in a parameter of the test fuel cell as the purge completion event.

11. The purge system of claim 10, wherein the purge complete module directs the purge stream over the cathode of the test fuel cell, and wherein the purge complete module detects a decrease in the test fuel cell voltage as the purge completion event.

12. The purge system of claim 11 wherein the fuel cell assembly is a fuel cell stack, wherein the test fuel cell is a fuel cell within the fuel cell stack.

13. The purge system of claim 9, wherein the purge complete module directs the purge stream over the anode of the test fuel cell, wherein the purge complete module detects an increase in a test fuel cell voltage past a predetermined voltage threshold as the purge completion event.

14. The purge system of claim 13, wherein the test fuel cell is an auxiliary fuel cell.

15. The purge system of claim 9, wherein the fuel detector includes a catalyst bed, wherein the purge complete module directs the purge stream mixed with ambient air over the catalyst bed, wherein the purge complete module detects an increase in temperature over the catalyst bed as the purge completion event.

16. The purge system of claim 15, wherein the catalyst bed includes a catalyst selected from the group consisting of platinum, palladium, ruthenium, manganese oxide, silver oxide and cobalt oxide.

17. A method of purging a fuel cell system, the fuel cell system including a fuel cell assembly, a fuel supply that supplies fuel to the fuel cell assembly at a first fuel flow rate, a purge valve coupled to the fuel cell assembly, and an adjustable load that applies a load on the fuel cell assembly; the method comprising the steps of:
a) detecting an initiation event;
b) adjusting a parameter of the fuel cell system to purge the fuel cell;
c) detecting a completion event; and
d) adjusting a parameter of the fuel cell system to cease the purge.

18. The method of claim 17, wherein step a) includes detecting a drop in the voltage of a fuel cell within the fuel cell assembly below a threshold voltage.

19. The method of claim 18, wherein the fuel cell assembly includes a plurality of fuel cells with in-series fuel routing, wherein the step of detecting a drop in the voltage of a fuel cell includes detecting the voltage drop of the last fuel cell in the fuel routing below the threshold voltage.

20. The method of claim 17, wherein step b) includes adjusting the load applied by the adjustable load on the fuel cell assembly.

21. The method of claim 20, wherein step b) includes decreasing the load on the fuel cell assembly such that the assembly pressure is increased.

22. The method of claim 21, wherein the purge valve is a passive valve, and wherein step b) includes decreasing the load such that the assembly pressure is increased above the cracking pressure of the purge valve.

23. The method of claim 21, wherein the purge valve is an active valve, and wherein step b) includes opening the purge valve.

24. The method of claim 17, wherein step b) further includes maintaining the first fuel flow rate during purging.

25. The method of claim 17, wherein step c) includes detecting a fuel concentration increase within a purge stream.

26. The method of claim 25, wherein detecting a fuel concentration increase includes routing the purge stream over a test fuel cell.

27. The method of claim 26, wherein detecting a fuel increase includes the steps of:
routing the purge stream over the cathode of the test fuel cell; and
detecting a voltage decrease in the test fuel cell.

28. The method of claim 27, wherein fuel cell assembly includes a fuel cell stack, wherein the test fuel cell is a fuel cell within the fuel cell stack.

29. The method of claim 26, wherein detecting a fuel increase includes the steps of:
routing the purge stream over the anode of the test fuel cell; and
detecting a voltage increase in the test fuel cell.

30. The method of claim 29, wherein the test fuel cell is an auxiliary fuel cell.

31. The method of claim 17, wherein step d) includes reversing the adjustment on the adjustable load.

32. The method of claim 31, wherein step d) includes increasing the load on the fuel cell assembly such that the assembly pressure is decreased.

33. The method of claim 32, wherein the purge valve is a passive valve, and wherein step d) includes increasing the load such that the assembly pressure is decreased under the cracking pressure of the purge valve.

34. The method of claim 17, wherein the purge valve is an active valve, wherein step d) includes closing the purge valve.
